(19) United States
(12) Patent Application Publication
(10) Pub. No.: US 2006/0062884 A1
(43) Pub. Date: Mar. 23, 2006

(54) Non fat - non sugar cocoa/carob pudding

(76) Inventor: Milner Benedict III, Tampa, FL (US)

Correspondence Address: Milner Benedict III, Apt. # 40 - C, 10610 North 30th, Tampa, FL, 33612, US

(21) Appl. No.: 10/946,179

(22) Filed: Sep. 21, 2004

(51) Int. Cl. A23L 1/187

(52) U.S. Cl. 426/579

(57) ABSTRACT

The key ingredient which makes my recipe for pudding novel is the substitution of 100% rolled oats, which has the added benefit of helping to lower cholesterol, for thickening agents such as cornstarch. The additions of unsweetened chocolate and carob powders also have health benefits for the consumer.

### BACKGROUND OF INVENTION

This invention involves the creation of a new type of pudding in the field of food manufacture and development. Presently, puddings are made with—(1) traditionally rich ingredients, such as milk and milk fat, cream, sugar, corn starch, or some other thickening agent, or (2) artificial food agents, which may or may not include fat and sugar ingredients. Unfortunately, most consumers are susceptible to the weight gain and other negative health-effects brought on by eating foods rich in the traditionally made puddings. When seeking alternatives, other consumers must avoid puddings altogether because of allergies to the artificial ingredients found in modernly-made pudding types. My new recipe for pudding solves these problems.

I came up with the pudding recipe over a period of several months. As a health-conscious person, I began thinking of new ways in which to prepare oatmeal. I started adding different flavors and ingredients. Then, I discovered that adding cocoa powder to oatmeal presented a consistency very similar to pudding, although the result lacked the aesthetic appearance of culinary desert.

I told my dad about the recipe, but suggested he refrigerate the food before consuming it. As it turned out, he loved the pudding-alternative. I thought about the recipe at length. That's when I decided to mix the ingredients, along with hot water, in a blender. My theory was that I could probably come up with something more visually appealing under rapid blending.

I tried a number of different proportions among the ingredients until finally coming up with the right mixture. Of course, if this product were mass produced, the dry ingredients would have to be blended together, creating a semi-fine powder. The consumer would then add hot water at home and refrigerate.

### BRIEF SUMMARY OF THE INVENTION

100% rolled oats is substituted for thickening agents, such as corn starch or other artificial thickeners, in a pudding recipe. Flavoring agents such as cocoa or carob, and sweeteners, such as stevia, are added with hot water. The result is a delicious, yet fat and sugar free, pudding.

### DETAILED DESCRIPTION OF THE INVENTION

There are three basic ingredients to the non fat—non sugar pudding. First, the key ingredient which serves as a thickening agent is 100% rolled oats, more commonly known as old fashioned oatmeal.

The second ingredient is a flavoring agent—in this case either 100% cocoa powder, otherwise known as chocolate powder or baking chocolate, or carob powder, which has a minimal amount of naturally occurring sugar that can be removed via food processing methods.

The third ingredient is a sweetening agent, such as aspartame, saccharin, or more preferably for those who do not want artificial sweetening, stevia. Stevia is an herb with a sweet taste that has been reported to actually lower blood glucose levels.

These ingredients are mixed together into a powder and placed in individual packets. Each packet would make 1 to 2 servings of pudding. The only action the consumer need do is pour the contents into a cup or bowl, add hot, boiling water, mix with a spoon, let the mixture stand at room temperature for about fifteen minutes, and then place into the refrigerator to cool.

1. What I first claim as my invention is the combination of ¾ cup of 100% rolled oats, one heaping tablespoon of cocoa power, and one heaping teaspoon of stevia powder into a unified mixture such that, when 1 and ⅔ cups of boiling water are added and allowed to cool in the refrigerator, a delicious yet fat and sugar free pudding is created:

2. What I secondly claim as my invention is the combination of ¾ cup of 100% rolled oats, one heaping tablespoon of carob powder, and one heaping teaspoon of stevia powder into a unified mixture such that, when 1 and ⅔ cups of boiling water are added and allowed to cool in the refrigerator, a delicious yet fat and sugar free pudding is created.

3. What I thirdly claim as my invention is the combination of ¾ cup of 100% rolled oats, one heaping tablespoon of cocoa power, and 1 and ½ teaspoons of aspartame powder into a unified mixture such that, when 1 and ⅔ cups of boiling water are added and allowed to cool in the refrigerator, a delicious yet fat and sugar free pudding is created.

4. What I fourthly claim as my invention is the combination of ¾ cup of 100% rolled oats, one heaping tablespoon of carob power, and 1 and ½ teaspoons of aspartame powder into a unified mixture such that, when 1 and ⅔ cups of boiling water are added and allowed to cool in the refrigerator, a delicious yet fat and sugar free pudding is created.

5. What I fifthly claim as my invention is the combination of ¾ cup of 100% rolled oats, one heaping tablespoon of cocoa power, and 1 and ½ teaspoons of saccharin powder into a unified mixture such that, when 1 and ⅔ cups of boiling water are added and allowed to cool in the refrigerator, a delicious yet fat and sugar free pudding is created.

6. What I sixthly claim as my invention is the combination of ¾ cup of 100% rolled oats, one heaping tablespoon of carob power, and 1 and ½ teaspoons of saccharin powder into a unified mixture such that, when 1 and ⅔ cups of boiling water are added and allowed to cool in the refrigerator, a delicious yet fat and sugar free pudding is created.
